(19) United States
(12) Patent Application Publication
(10) Pub. No.: US 2018/0129108 A1
(43) Pub. Date: May 10, 2018

(54) DISPLAY APPARATUS

(71) Applicant: Samsung Display Co., Ltd., Yongin-si (KR)

(72) Inventors: Jinsu LEE, Yongin-si (KR); Hyoungcheol LEE, Yongin-si (KR); Minwook PARK, Yongin-si (KR); Hawon YU, Yongin-si (KR)

(21) Appl. No.: 15/803,832

(22) Filed: Nov. 5, 2017

(30) Foreign Application Priority Data
Nov. 9, 2016 (KR) 10-2016-0148879

(51) Int. Cl. G02F 1/1362; G02F 1/1335

(52) U.S. Cl. CPC G02F 1/136209; G02F 2001/134345; G02F 1/133514

(57) ABSTRACT

A display device includes: a substrate including a plurality of sub-pixel areas and a non-pixel area between the plurality of sub-pixel areas; a plurality of color filters disposed on the plurality of sub-pixel areas to respectively correspond to the plurality of sub-pixel areas; a black matrix on the non-pixel area; and a column spacer on the black matrix. The black matrix includes a concave portion, and the column spacer is on the concave portion.

### CROSS-REFERENCE TO RELATED APPLICATION

This application claims priority from and the benefit of Korean Patent Application No. 10-2016-0148879, filed on Nov. 9, 2016, which is hereby incorporated by reference for all purposes as if fully set forth herein.

### BACKGROUND

### Field

Exemplary embodiments relate to a display apparatus.

### Discussion of the Background

As various electronic devices such as mobile phones, personal digital assistants (PDAs), computers, and large-screen TVs have been developed, the demand for flat-panel display devices for use with such various electronic devices has increased. Among flat-panel display devices, liquid-crystal display (LCD) devices have advantages of low power consumption, easy display of moving images, a high contrast ratio, etc.

An LCD device includes a liquid crystal layer between two display panels, and changes the polarization of incident light by changing the alignment direction of liquid crystal molecules by applying an electrical field to the liquid crystal layer and interoperates the changed polarization with a polarizer to control whether to transmit incident light according to pixels, thereby displaying an image.

In the case of existing LCD devices, it is difficult to stably secure a cell gap because a column spacer, which is formed simultaneously with an organic film, collapses during a curing process.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a liquid-crystal display (LCD) device for securing a taper angle of a column spacer. However, the scope of the present disclosure is not limited thereto.

Additional aspects will be set forth in the detailed description which follows, and, in part, will be apparent from the disclosure, or may be learned by practice of the inventive concepts.

According to one or more exemplary embodiments, a display device includes: a substrate including a plurality of sub-pixel areas and a non-pixel area between the plurality of sub-pixel areas; a plurality of color filters disposed on the plurality of sub-pixel areas to respectively correspond to the plurality of sub-pixel areas; a black matrix on the non-pixel area; and a column spacer on the black matrix, wherein the black matrix includes a concave portion, and the column spacer is on the concave portion.

The display device may further include an organic film on the plurality of color filters, and the column spacer may include the same material as the organic film.

In the black matrix, at least two of a plurality of color patterns having different colors may overlap each other.

At least one of the plurality of color patterns may be connected to at least one of the plurality of color filters which extends to the non-pixel area.

At least one of the plurality of color patterns may include a first point and a second point, the first point may be at a central portion of the concave portion and the second point may be at an outer portion of the concave portion. A height of the at least one color pattern at the second point may be greater than a height of the at least one color pattern at the first point.

At least one of the plurality of color patterns may include an opening overlapping the concave portion.

A width of the opening may be less than a width of the concave portion.

The concave portion may include a first surface and a second surface. The first surface may be flat and have a first height, and the second surface may be connected to the first surface and have a height increasing from the first height to a second height that is greater than the first height.

A bottom surface of the column spacer may be on the first surface.

A portion of a bottom surface of the column spacer may be on the second surface.

A width of a bottom surface of the column spacer may be less than a width of the concave portion.

The display device may further include a thin film transistor (TFT) between the substrate and the black matrix, and the concave portion may be on the TFT.

According to one or more embodiments, a display device includes: a first substrate including a plurality of sub-pixel areas and a non-pixel area between the plurality of sub-pixel areas; a second substrate facing the first substrate; a liquid crystal layer between the first substrate and the second substrate; a plurality of color filters being on the plurality of sub-pixel areas to respectively correspond to the plurality of sub-pixel areas on the first substrate; a black matrix on the non-pixel area; and a column spacer on the black matrix. The black matrix includes a concave portion, and the column spacer is on the concave portion.

The display device may further include an organic film on the plurality of color filters, and the column spacer may include the same material as the organic film.

In the black matrix, at least two of a plurality of color patterns having different colors may overlap each other.

At least one of the plurality of color patterns may include a first point and a second point. The first point may be at a central portion of the concave portion and the second point may be at an outer portion of the concave portion, and a height of the at least one color pattern at the second point may be greater than a height of the at least one color pattern at the first point.

At least one of the plurality of color patterns may include an opening overlapping the concave portion.

A width of a bottom surface of the column spacer may be less than a width of the concave portion.

The display device may further include a thin film transistor (TFT) between the first substrate and the black matrix, and the concave portion may be on the TFT.

The display device may further include a TFT being on the second substrate, and the concave portion is at a location corresponding to the TFT.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a plan view of a display device according to an exemplary embodiment.

FIG. 2 is a cross-sectional view of an example of a cross section taken along a line I-I′ of FIG. 1.

FIG. 3 is a cross-sectional view of another example of a cross section taken along the line I-I′ of FIG. 1.

FIG. 4 is a cross-sectional view of a display device according to another exemplary embodiment.

FIGS. 5A, 5B, 5C are conceptual views of an opening in a color pattern in a region A of FIG. 1.

FIG. 6 is a cross-sectional view of a display device according to another exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not necessarily intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

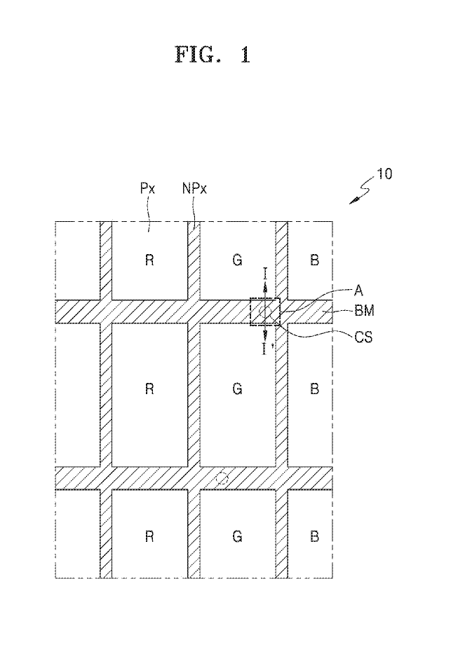

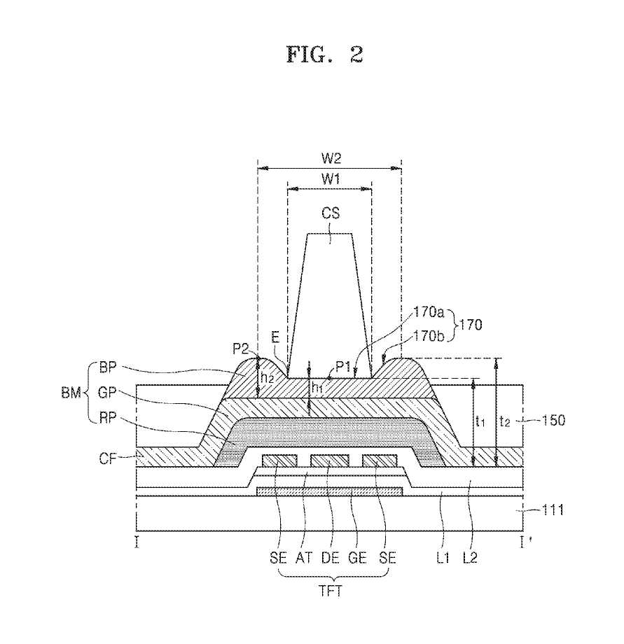

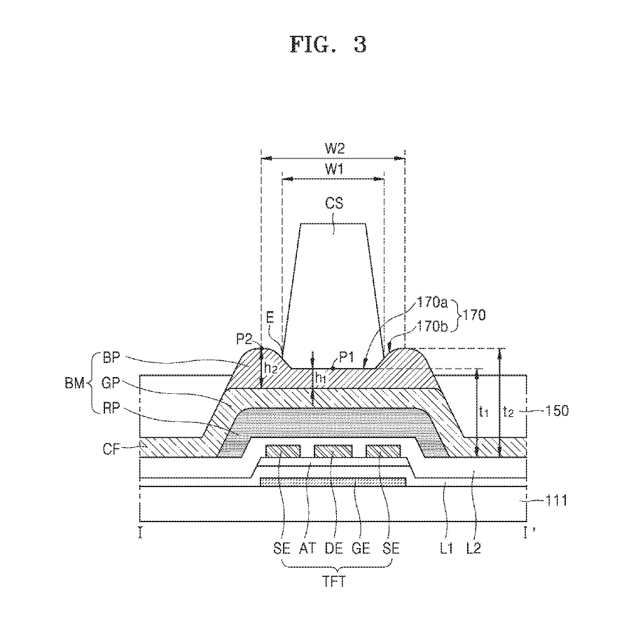

FIG. 1 is a plan view of a display device 10 according to an exemplary embodiment. FIG. 2 is a cross-sectional view of an example of a cross section taken along a line I-I′ of FIG. 1. FIG. 3 is a cross-sectional view of another example of a cross section taken along the line I-I′ of FIG. 1.

Referring to FIGS. 1 to 3, the display device 10 according to an exemplary embodiment may include a substrate 111, color filters CF, a black matrix BM, and a column spacer CS.

The substrate 111 may include sub-pixel areas Px and a non-pixel area NPx between the sub-pixel areas Px. The substrate 111 may include transparent glass or transparent plastic including SiO₂. In order to prevent penetration of impurities, a buffer layer (not shown) including SiO₂ and/or SiNₓ may be further formed on the substrate 111. Each sub-pixel area Px may be a display area where red (R), green (G), or blue (B) is displayed. The non-pixel area NPx may be a non-display area outside the display area.

The color filters CF may be disposed in the sub-pixel areas Px to correspond to the sub-pixel areas Px, respectively. The color filters CF may be respectively in the sub-pixel areas Px in such a manner that R, G, or B is displayed in each sub-pixel area Px. Although the display areas in each of which R, G, or B is displayed are arranged in a lattice pattern in FIG. 1, the exemplary embodiments are not limited thereto. The sub-pixel areas Px may be arranged in any of various patterns and may further include a sub-pixel area Px for providing white light.

The black matrix BM may be in the non-pixel area NPx. The black matrix BM may prevent light leakage and color mixture occurring between the sub-pixel areas Px, and since light incident to a surface of the black matrix BM is absorbed by the black matrix BM, the incident light may not be visible by a user on an opposite surface facing the surface of the black matrix BM.

According to an exemplary embodiment, the black matrix BM may be formed as at least two color patterns having different colors overlapping each other, the at least two color patterns being selected from among a red pattern RP, a green pattern GP, and a blue pattern BP. In the drawings, the red pattern RP, the green pattern GP, and the blue pattern BP are sequentially stacked, but an order of stacking the color patterns is not limited thereto. Also, at least one of the color patterns (e.g., the red pattern RP, the green pattern GP, and the blue pattern BP) may be connected to at least one color filter CF extending towards the non-pixel area NPx. Referring to FIGS. 2 and 3, the green pattern GP may be connected to a green color filter in an adjacent sub-pixel area Px. FIGS. 2 and 3 illustrate that the red pattern RP is not connected to a red color filter, but may be connected to the red color filter in an area that is not illustrated. The blue pattern BP may also be connected to a blue color filter in an area that is not illustrated in FIGS. 2 and 3. The black matrix BM may absorb light that is incident to the black matrix BM, since the color patterns having different colors are stacked in the black matrix BM.

The black matrix BM may include a concave portion 170 on which the column spacer CS is located. A first height t1 of a central portion of the concave portion 170 may be less than a second height t2 of an outer portion of the concave portion 170. In an exemplary embodiment, a first height h1 of a central portion of at least one color pattern, which overlaps the concave portion 170, may be less than a second height h2 of a portion of the at least one color pattern, which corresponds to the outer region of the concave portion 170. In particular, at least one color pattern includes a first point P1 and a second point P2. The first point P1 may be at the central portion of the concave portion 170, and the second point P2 may be at the outer portion of the concave portion 170. The second height h2 at the second point P2 may be greater than the first height h1 at the first point P1. In the drawings, the blue pattern BP, which is a color pattern on a top portion of the black matrix BM, has a concave shape, but the exemplary embodiments are not limited thereto. A color pattern on a middle or bottom portion of the black matrix BM may have a concave portion, or all color patterns (e.g., the red pattern RP, the green pattern GP, and the blue pattern BP) may have concave shapes. The concave portion of the color pattern may be formed using a half-tone mask or a slit mask.

The concave portion 170 may include a first surface 170a and a second surface 170b. The first surface 170a is flat and has the first height t1, and the second surface 170b is connected to the first surface 170a and has a height increasing from the first height h1 to the second height h2 that is greater than the first height h1. The second surface 170b may be an inclined surface having a certain gradient. In another exemplary embodiment, the second surface 170b may be a surface having a height that changes exponentially or logarithmically.

The column spacer CS may be on the black matrix BM, especially, on the concave portion 170. The column spacer CS and an organic film 150 on the color filter CF may be formed by using the same process and may include the same material. The column spacer CS and the organic film 150 may be formed by simultaneously patterning organic materials by using a photo mask, the organic materials being coated to cover the color filters CF and the black matrix BM. In this case, the photo mask may be either a halftone mask or a slit mask. As illustrated in the drawings, an organic material in a region between the column spacer CS and the organic film 150 is completely removed such that the column spacer CS may be patterned to be separated from the organic film 150. However, in another exemplary embodiment, the column spacer CS may be connected to the organic film 150. With respect to the substrate 111, the column spacer CS may have a pillar shape having a uniform taper angle and maintain a gap between the column spacer CS and another substrate facing the substrate 111.

In this case, the column spacer CS may be reflowed and collapse during a curing process. When the column spacer CS collapses, the taper angle of the column spacer CS decreases, and thus a width of the column spacer CS decreases. In this regard, a compression ratio of the column spacer CS decreases, and thus it is difficult to uniformly maintain a cell gap.

The display device 10 according to an exemplary embodiment is designed to solve such problems. In the display device 10, as the column spacer CS is located on the concave portion 170 of the black matrix BM, the column spacer CS may be supported by using the concave portion 170 so as to prevent the collapse of the column spacer CS during a curing process.

In an exemplary embodiment, as illustrated in FIG. 2, a bottom surface of the column spacer CS may be on the first surface 170a of the concave portion 170. Since the bottom surface of the column spacer CS is on the first surface 170a of the concave portion 170, the column spacer CS may be stably mounted on the concave portion 170. A width W1 of the column spacer CS has to be less than a width W2 of the concave portion 170 so that the concave portion 170 may support the column spacer CS. Also, during a curing process, the reflow and the collapse of the column spacer CS during a curing process may be prevented. In another exemplary embodiment, as illustrated in FIG. 3, part of the bottom surface of the column spacer CS may be on the second surface 170b of the concave portion 170. In particular, an edge E of the bottom surface of the column spacer CS may be on the second surface 170b. Since the edge E of the bottom surface of the column spacer CS is on the second surface 170b that is the inclined surface, it is easy to distribute pressure applied to the column spacer CS through a top surface thereof, and thus compression characteristics of the column spacer CS may be improved.

A driving device including a thin film transistor (TFT) may be between the substrate 111 and the black matrix BM.

The TFT may be in the non-pixel area NPx and may include a gate electrode GE, a semiconductor layer AT, source electrodes SE, and a drain electrode DE. A first insulating layer L1 is on the gate electrode GE to insulate the gate electrode GE and the semiconductor layer AT from each other. Also, a second insulating layer L2 may cover the source electrodes SE, the drain electrode DE, and exposed top portions of the semiconductor layer AT.

In an exemplary embodiment, the concave portion 170 of the black matrix BM may be above the TFT. In another exemplary embodiment, the black matrix BM, the color filter CF, and the column spacer CS may be on a substrate different from a substrate on which the TFT is located.

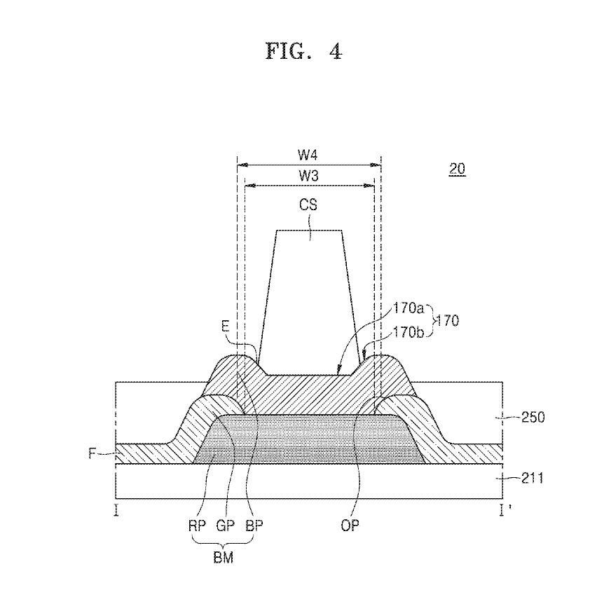

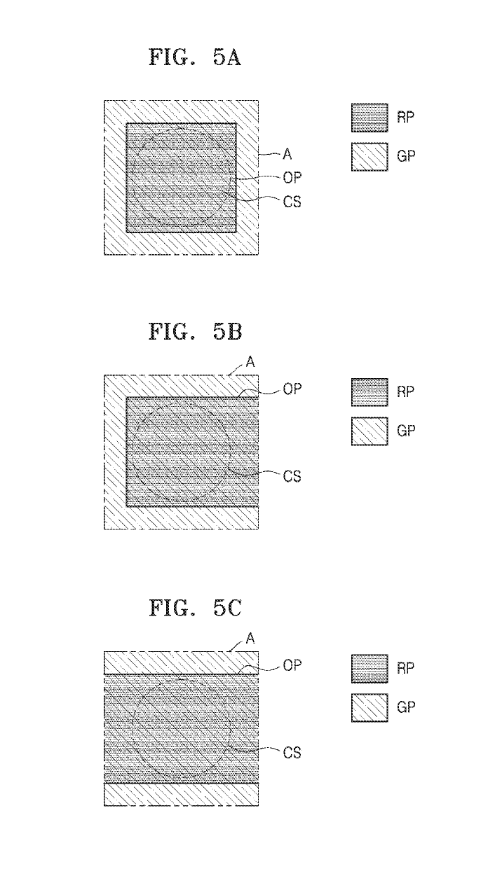

FIG. 4 is a cross-sectional view of a display device 20 according to another exemplary embodiment. FIGS. 5A to 5C are conceptual views of an opening in a color pattern in a region A of FIG. 1.

Referring to FIG. 4, the display device 20 may include the substrate 111, the color filters CF, the black matrix BM, and the column spacer CS. The display device 20 according to another exemplary embodiment includes the same components as the display device 20 except for a stack structure of the concave portion 170 of the black matrix BM, and thus repeated descriptions will not be provided. For convenience of explanation, FIG. 4 mainly illustrates a relation between the black matrix BM and the column spacer CS.

The substrate 211 may include sub-pixel areas Px and a non-pixel area NPx between the sub-pixel areas Px. The color filters CF may be on the sub-pixel areas Px to respectively correspond to the sub-pixel areas Px.

The black matrix BM may be in the non-pixel area NPx. The black matrix BM may include the concave portion 170 on which the column spacer CS is located. The black matrix BM may be formed as at least two color patterns having different colors overlap each other, the at least two color patterns being selected from among the colors patterns, for example, the red pattern RP, the green pattern GP, and the blue pattern BP. In this case, at least one of the red pattern RP, the green pattern GP, and the blue pattern BP may include an opening OP overlapping the concave portion 170. The opening OP may expose a top surface of a lower layer of the color pattern in which the opening OP is formed. The black matrix BM includes the color pattern (the green pattern GP) including the opening OP, and the concave portion 170 may be formed by stacking the color patterns having different colors. In this case, a width W3 of the opening OP may be less than a width W4 of the concave portion 170. As described above, when the opening OP is used, the concave portion 170 may be formed without a change in widths of the color patterns according to an exemplary embodiment.

FIGS. 5A to 5C illustrate various exemplary embodiments of a shape of the opening OP included in the green pattern GP among the color patterns. For convenience of explanation, FIGS. 5A to 5C schematically illustrate the green pattern GP including the opening OP of FIG. 4 and the red pattern RP located on a bottom of the green pattern GP.

Referring to FIGS. 5A to 5C, the opening OP of the green pattern GP may be patterned in a square pattern. As illustrated in FIG. 5A, when the opening OP is patterned in a square pattern, the concave portion 170 surrounding an outer region of the column spacer CS may be formed. In another exemplary embodiment, as illustrated in FIG. 5B, the opening OP may be patterned in a ‘[’ pattern of which one side is open. In another exemplary embodiment, as illustrated in FIG. 5C, the opening OP may be patterned in a rectangular pattern of which both sides are open.

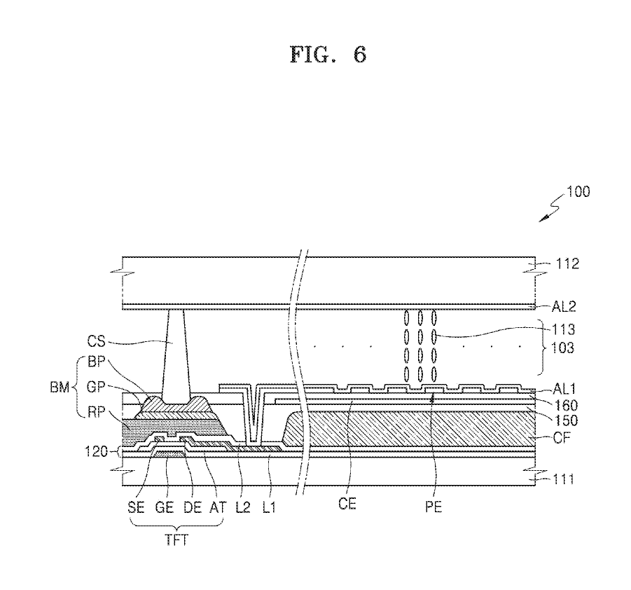

FIG. 6 is a cross-sectional view of a display device 100 according to another exemplary embodiment.

Here, a case where the display device 100 is an LCD device will be described. However, the exemplary embodiments are not limited thereto, and the exemplary embodiments may be applied to any type of the display device 100 including the black matrix BM and the column spacer CS.

The LCD device 100 displays an image based on a principle in which light emitted from a backlight unit, etc. is incident to a polarizer (not shown) and then to the liquid crystal layer 103 after the polarization in a certain direction; and after a direction of the polarization is controlled by the liquid crystal layer 103, light passing through at least some pixels in the liquid crystal layer 103 passes through another polarizer (not shown), and finally the light is detected by a user.

Referring to FIG. 6, the display device 100 may include a first substrate 111, the liquid crystal layer 103 located above the first substrate 111 and including liquid crystal molecules 113, and a pixel electrode PE and a common electrode CE for applying an electrical field to the liquid crystal layer 103. Also, the LCD device 100 may include a second substrate 112 facing the first substrate 111.

On the first substrate 111, a TFT array layer 120, the color filter CF, the common electrode CE, the pixel electrode PE, and a first alignment layer AL1 may be formed. In another exemplary embodiment, the TFT array layer 120 and the pixel electrode PE may be formed on the second substrate 112.

The first substrate 111 may be a glass substrate or a plastic substrate including polyethylene terephthalate (PET), polyethylene naphthalate (PEN), polyimide, etc.

The TFT array layer 120 includes switching devices TFT and also includes gate lines and data lines that are not illustrated. The switching device TFT is a thin film transistor and includes a semiconductor layer AT, a gate electrode GE, a source electrode SE, and a drain electrode DE.

The first insulating layer L1 that is a gate insulating layer is formed on the gate electrode GE, and the semiconductor layer AT is formed on the first insulating layer L1. On the semiconductor layer AT, the gate electrode GE and the second electrode SE are apart from each other, and a second insulating layer L2 covering the gate electrode GE and the second electrode SE is formed. FIG. 6 illustrates an example of a thin film transistor of a bottom-gate type in which the gate electrode GE is under the semiconductor layer AT. However, the exemplary embodiments are not limited thereto, and a thin film transistor of any of various types such as a top-gate type in which the gate electrode GE is above the semiconductor layer AT.

The semiconductor layer AT includes various materials. For example, the semiconductor layer AT may include an inorganic semiconductor material such as amorphous silicon or polycrystalline silicon. As another example, the semiconductor layer AT may include an oxide semiconductor. As another example, the semiconductor layer AT may include an organic semiconductor material.

The gate electrode GE, the source electrode SE, and the drain electrode DE may each be a single layer or multiple layers including at least one metal selected from among aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu).

The first insulating layer L1 and the second insulating layer L2 may each include various insulating materials. The first insulating layer L1 and the second insulating layer L2 may each be a single insulating layer or multiple insulating layers including at least one selected from among SiO₂, SiNₓ, SiON, aluminum oxide (Al₂O₃), titanium oxide (TiO₂), tantalum pentoxide (Ta₂Os), hafnium oxide (HfO₂), zirconium oxide (ZrO₂), barium strontium titanate (BST), and lead zirconate titanate (PZT).

The color filter CF may be formed on the TFT array layer 120. The organic film 150 may be formed on the color filter CF, and the common electrode CE may be located on the organic film 150. The black matrix BM may be on a portion of the TFT array layer 120 which corresponds to the thin film transistor TFT, and the column spacer CS may be on the black matrix BM. In this case, the black matrix BM may include a concave portion, and the column spacer CS may be on the concave portion.

In an exemplary embodiment, the black matrix BM may be formed as at least two color patterns having different colors overlap each other, the at least two color patterns being selected from among the colors patterns, for example, the red pattern RP, the green pattern GP, and the blue pattern BP. The black matrix BM has the stack structure of the color patterns having different colors and thus may absorb light that is incident to the black matrix BM.

As the column spacer CS is on the concave portion 170 of the black matrix BM, the column spacer CS may be supported by using the concave portion 170 so as to prevent the collapse of the column spacer CS during a curing process.

The pixel electrode PE may be on the common electrode CE with a third insulating layer 160 therebetween. Thus, when a voltage is applied to the common electrode CE and the pixel electrode PE, a horizontal electrical field may be generated parallel to the first substrate 111, and an alignment of the liquid crystal molecules 113 of the liquid crystal layer 103 may be changed by the horizontal electrical field. When the voltage is applied to the common electrode CE and the pixel electrode PE, an electrical field is applied to the liquid crystal layer 103 and then changes the alignment of the liquid crystal molecules 113 in order to adjust an amount of light passing through the liquid crystal layer 103. Accordingly, the LCD device 100 may display an image.

As described above, in the display device according to the exemplary embodiments, a column spacer is on a concave portion of a black matrix, and thus a shape change of the column spacer may be minimized while the display device is manufactured. Also, in the display device according to the exemplary embodiments, it is possible to distribute pressure applied to the column spacer through the concave portion of the black matrix, and thus a compression ratio of the column spacer may be improved.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A display device, comprising:
a substrate comprising a plurality of sub-pixel areas and a non-pixel area between the plurality of sub-pixel areas;
a plurality of color filters disposed on the plurality of sub-pixel areas to respectively correspond to the plurality of sub-pixel areas;
a black matrix disposed on the non-pixel area; and
a column spacer disposed on the black matrix,
wherein the black matrix comprises a concave portion, and
the column spacer is disposed on the concave portion.

2. The display device of claim 1, further comprising an organic film disposed on the plurality of color filters,
wherein the column spacer comprises a same material as the organic film.

3. The display device of claim 1, wherein the black matrix comprises at least two of a plurality of color patterns having different colors that overlap each other.

4. The display device of claim 3, wherein at least one of the plurality of color patterns is connected to at least one of the plurality of color filters which extends to the non-pixel area.

5. The display device of claim 3, wherein at least one of the plurality of color patterns comprises a first point and a second point,
the first point is at a central portion of the concave portion and the second point is at an outer portion of the concave portion, and
a height of the at least one color pattern at the second point is greater than a height of the at least one color pattern at the first point.

6. The display device of claim 3, wherein at least one of the plurality of color patterns comprises an opening overlapping the concave portion.

7. The display device of claim 6, wherein a width of the opening is less than a width of the concave portion.

8. The display device of claim 1, wherein the concave portion comprises a first surface and a second surface,
the first surface is flat and has a first height, and
the second surface is connected to the first surface and has a height increasing from the first height to a second height that is greater than the first height.

9. The display device of claim 8, wherein a bottom surface of the column spacer is on the first surface.

10. The display device of claim 8, wherein a portion of a bottom surface of the column spacer is on the second surface.

11. The display device of claim 1, wherein a width of a bottom surface of the column spacer is less than a width of the concave portion.

12. The display device of claim 1, further comprising a thin film transistor (TFT) disposed between the substrate and the black matrix, and
wherein the concave portion is on the TFT.

13. A display device, comprising:
a first substrate comprising a plurality of sub-pixel areas and a non-pixel area between the plurality of sub-pixel areas;
a second substrate facing the first substrate;
a liquid crystal layer between the first substrate and the second substrate;
a plurality of color filters disposed on the plurality of sub-pixel areas to respectively correspond to the plurality of sub-pixel areas on the first substrate;
a black matrix disposed on the non-pixel area; and
a column spacer disposed on the black matrix,
wherein the black matrix comprises a concave portion, and
the column spacer is disposed on the concave portion.

14. The display device of claim 13, further comprising an organic film disposed on the plurality of color filters,
wherein the column spacer comprises a same material as the organic film.

15. The display device of claim 13, wherein the black matrix comprises at least two of a plurality of color patterns having different colors that overlap each other.

16. The display device of claim 15, wherein at least one of the plurality of color patterns comprises a first point and a second point,
the first point is at a central portion of the concave portion and the second point is at an outer portion of the concave portion, and
a height of the at least one color pattern at the second point is greater than a height of the at least one color pattern at the first point.

17. The display device of claim 15, wherein at least one of the plurality of color patterns comprises an opening overlapping the concave portion.

18. The display device of claim 13, wherein a width of a bottom surface of the column spacer is less than a width of the concave portion.

19. The display device of claim 13, further comprising a thin film transistor (TFT) disposed between the first substrate and the black matrix, and
wherein the concave portion is disposed on the TFT.

20. The display device of claim 13, further comprising a thin film transistor (TFT) disposed on the second substrate,
wherein the concave portion is disposed at a location corresponding to the TFT.
